(19) United States
(12) Patent Application Publication
(10) Pub. No.: US 2014/0167311 A1
(43) Pub. Date: Jun. 19, 2014

(54) CONTAINER FORMING PROCESS

(71) Applicant: Berry Plastics Corporation, Evansville, IN (US)

(72) Inventors: Chris K. Leser, Evansville, IN (US); Philip A. Driskill, Newburgh, IN (US); John B. Euler, Evansville, IN (US); Jeffrey A. Mann, Evansville, IN (US); David Dezhou Sun, Evansville, IN (US); Jared B. Waterman, Evansville, IN (US)

(21) Appl. No.: 14/108,142

(22) Filed: Dec. 16, 2013

Related U.S. Application Data
(60) Provisional application No. 61/737,564, filed on Dec. 14, 2012.

(51) Int. Cl. B29C 51/14; B29C 51/08; B29C 51/02

(52) U.S. Cl. CPC B29C 51/14; B29C 51/02; B29C 51/082
USPC 264/132; 264/134

(57) ABSTRACT

A container includes a body formed to include an interior region and a floor coupled to a lower portion of the body to form a boundary of the interior region. A thermoforming process is provided for making the container using a polymeric material.

### PRIORITY CLAIM

This application claims priority under 35 U.S.C. §119(e) to U.S. Provisional Application Ser. No. 61/737,564, filed Dec. 14, 2012, which is expressly incorporated by reference herein.

### BACKGROUND

The present disclosure relates to polymeric materials that can be thermoformed to produce a container, and particularly to a process for forming such containers. More particularly, the present disclosure relates to deep-draw thermoforming, medium-draw thermoforming, and shallow-draw thermoforming methods for making a container out of a polymeric material.

### SUMMARY

A process in accordance with the present disclosure is provided for thermoforming an insulative container comprising a polymeric material. In illustrative embodiments, the process comprises the steps of extruding a strip made of an insulative cellular non-aromatic polymeric material, applying a coating to the strip to form a sheet, and thermoforming the sheet to produce insulative containers having a first layer comprising the insulative cellular non-aromatic polymeric material and a second layer comprising the coating.

In one illustrative embodiment, the insulative container is a drink cup. In another illustrative embodiment, the insulative container is a tray.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective diagrammatic view of a thermoforming process for making containers in accordance with the present disclosure showing that the process includes the steps of heating a multilayer sheet comprising a strip of polymeric material and a coating on the strip to an elevated temperature, thermoforming the heated sheet in a mold to produce a series of containers joined together by a thin container-carrier web, separating the containers from the web, and accumulating the separated containers to produce several stacks of nested individual containers;

FIG. 2 is an enlarged sectional view taken along line 2-2 of FIG. 1 after the heated sheet shown in FIG. 1 has been positioned in a mold cavity formed between an upper female mold core and a lower male mold core shown in FIG. 1 and the cores have moved toward one another to form therebetween the set of individual containers and the container-carrier web that is coupled to each of those containers;

FIG. 3 is a perspective view of a drink cup that has been formed from an insulative container that has been thermoformed as suggested in FIG. 1 and showing that the drink cup includes a body and floor, an upper portion of the body has been rolled in a brim former to form a rolled brim on top of a sleeve-shaped side wall of the body, and that a portion of the side wall of the body has been broken away to show that the side wall has inner and outer layers;

FIG. 4 is an enlarged view of a portion of the side wall included in the body of the drink cup and illustrated in a circled region of FIG. 3 showing that the side wall is made from the multilayer sheet shown in FIG. 1 comprising a first layer defined by an inner strip (on the right) made of a polymeric material such as an insulative cellular non-aromatic polymeric material and a second layer defined by an outer coating (on the left) applied to the inner strip;

FIG. 5 is a perspective view of a tray that has been formed from another insulative container in accordance with the present disclosure;

FIG. 6 is a sectional view of the tray taken along line 6-6 of FIG. 5 showing that each of a brim, side wall, and floor included in the tray comprises first and second layers;

FIG. 7 is an enlarged view of a portion of the first and second layers included in the tray and illustrated in a circled region of the floor of FIG. 6 suggesting that an outer first layer is made of a polymeric material such as an insulative cellular non-aromatic polymeric material and that an inner second layer is made of a coating applied to an inner surface of the outer first layer; and

FIG. 8 is a diagrammatic and perspective view of extruding and coating steps in a sheet-forming process in accordance with the present disclosure showing that the sheet-forming process includes, from left to right, a formulation of insulative cellular non-aromatic polymeric material being placed into a hopper that is fed into a first extrusion zone of a first extruder where heat and pressure are applied to form molten resin and showing that a blowing agent is injected into the molten resin to form an extrusion resin mixture that is fed into a second extrusion zone of a second extruder where the extrusion resin mixture exits and expands to form an extrudate which is slit to form a strip of insulative cellular non-aromatic material that is fed through a downstream strip coater which applies a coating to one side of the strip of insulative cellular non-aromatic material to produce a multilayer sheet.

### DETAILED DESCRIPTION

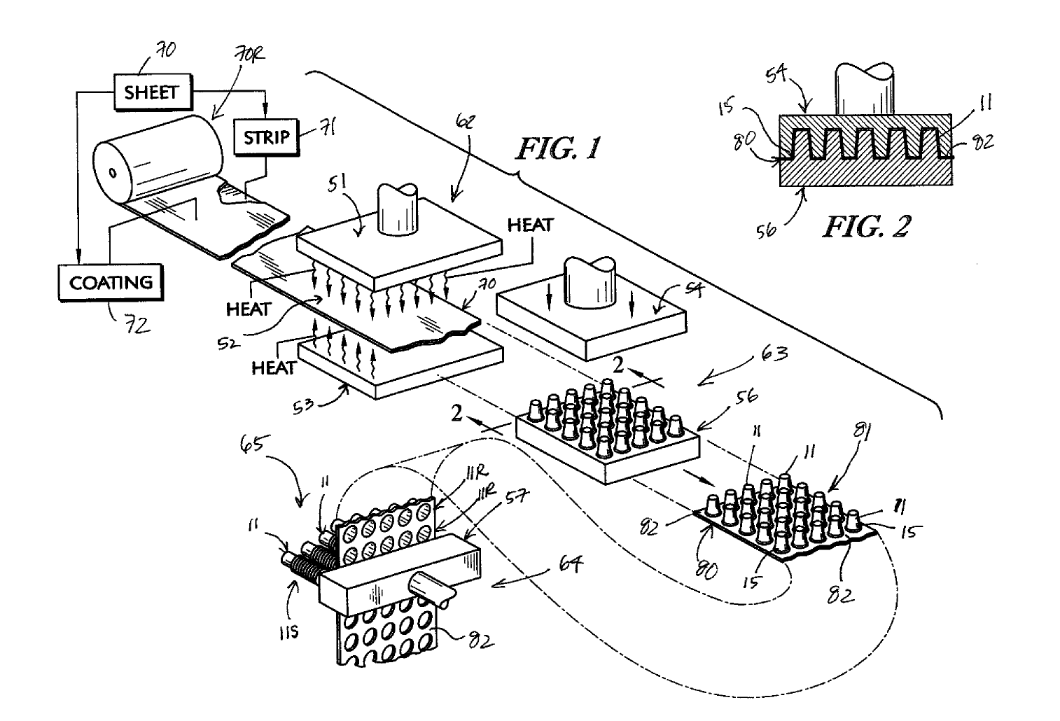

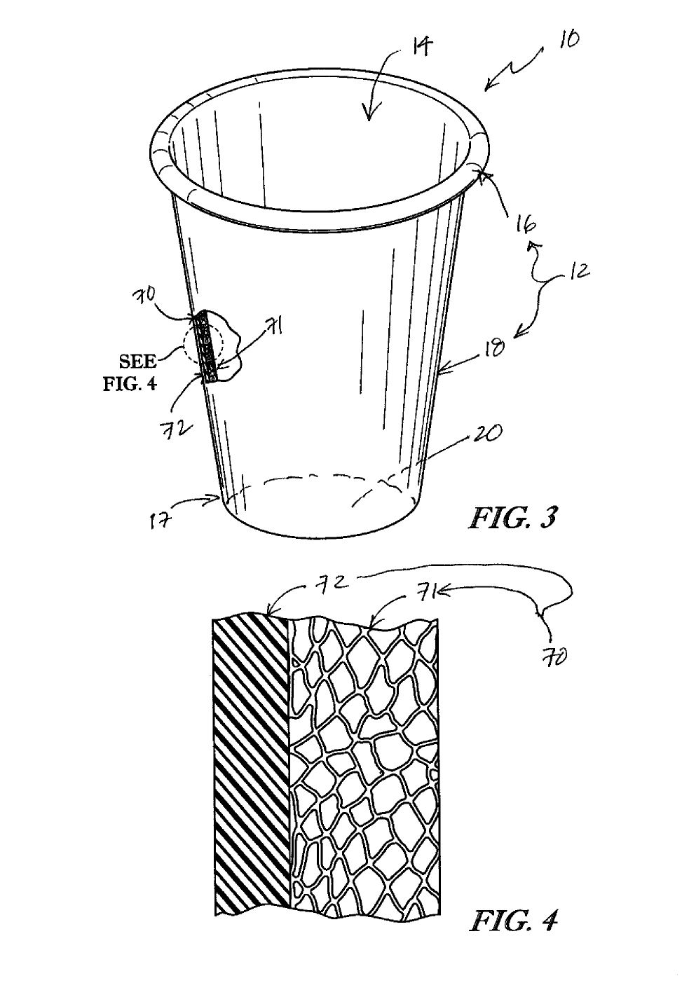

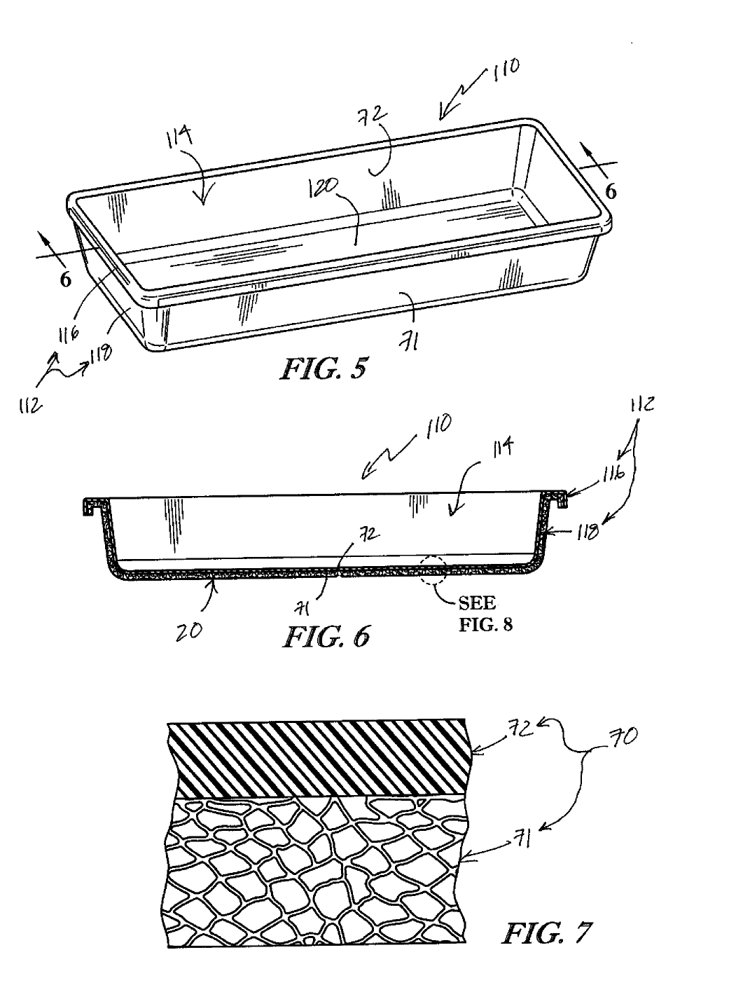

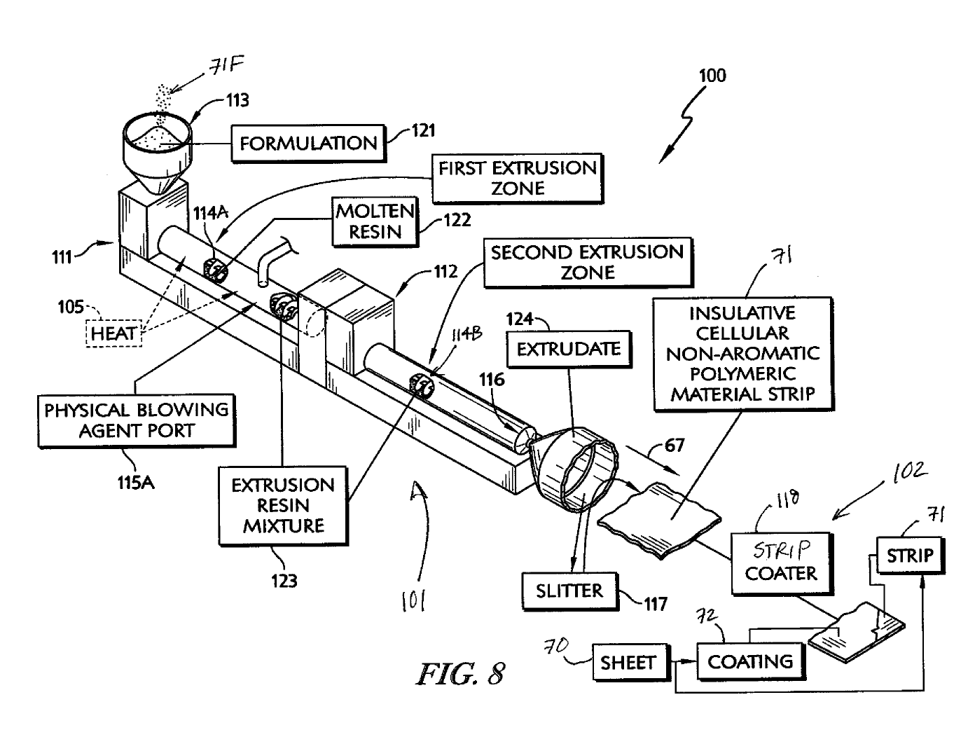

A drink 10 cup shown in FIG. 3 is formed using an illustrative manufacturing process in accordance with the present disclosure. This process includes a container-thermoforming process shown, for example, in FIG. 1 that is followed to form containers 11 from a multilayer sheet 70. Multilayer sheet 70 is formed in accordance with the present disclosure using a polymeric material extruding and coating process shown diagrammatically in FIG. 8. Each container 11 can be converted into a drink cup 10 by using a brim former to form a rolled brim 16 on an upper portion of the body 12 of the container 11. The illustrative container-thermoforming process can also be used with a suitable brim former to form a tray 110 shown in FIG. 5.

Container-thermoforming process includes a series of steps used to make a container 11 having an unrolled brim 15 as shown in FIGS. 1 and 2. Container-thermoforming process includes, in series, a heating step 62, a molding step 63, a stamping step 64, and an accumulating step 65. In an illustrative embodiment, a continuous sheet 70 made of two layers 71, 72 has been made using an extracting and coating process that is shown, for example, in FIG. 8. Heating step 62 heats continuous multilayer sheet 70. Molding step 63 molds continuous multilayer sheet 70 into a continuous molded sheet 80 that includes a set (e.g., array) 81 of containers 11 and a container-carrier web 82 coupled to each container 11. Stamping step 64 separates containers 11 from container-carrier web 82. Accumulating step 65 accumulates containers 11 to produce several stacks 11S of nested containers 11 as shown in FIG. 1. Each stack 11S of nested containers 11 is then transported to a brim-former station (not shown) wherein a brim-forming process is carried out to convert each container 11 into a drink cup 10 by rolling unrolled brim 15 to produce a rolled brim 16.

A continuous multilayer sheet 70 is formed at a given rate and sufficient thickness to support downstream processes such as heating step 62 and molding step 63. Continuous multilayer sheet 70 is made using, for example, an extruder machine 111, 112, 116, 117 and a strip coater 118 as suggested in FIG. 8. Extruder machine 111, 112, 116, 117 is supplied with raw pellets made of a suitable plastics material such as an insulative cellular non-aromatic polymeric material, which pellets are then heated and formed to product a continuous strip 71 as suggested in FIG. 1. Strip coater 118 applies a coating 72 to one side of strip 71 to produce a continuous multilayer sheet 70.

Continuous multilayer sheet 70 is unrolled and heated as suggested in FIG. 1 when sheet 70 is passed through a channel 52 formed between an upper heater 51 and a companion lower heater 53 as shown in FIG. 1. Upper and lower heaters 51, 53 cooperate to apply heat to continuous multilayer sheet 70 to cause sheet 70 to be heated to a temperature appropriate for thermoforming in molding step 63.

A portion of continuous multilayer sheet 70 is positioned in an illustrative mold cavity 55 formed between an upper female mold core 54 and a companion lower male mold core 56 as suggested in FIG. 2. During a molding step 63, cores 54 and 56 move toward one another to engage and deform multilayer sheet 70 to form a continuous molded sheet 80 as illustrated in FIG. 1. Continuous molded sheet 80 includes a set 81 of individual multilayer containers 11 and a multilayer container-carrier web 82 coupled to containers 11 as shown in FIG. 1. After the molding step 63 is completed, mold cores 54 and 56 move apart from one another and continuous molded sheet 80 moves in a downstream direction toward a stamping machine 57.

Continuous molded sheet 80 is moved through a stamping machine 57 where multilayer containers 11 are separated from multilayer container-carrier web 82 as shown in FIG. 1. As an example, each row 11R of containers 11 are separated one at a time. However, containers 11 from several rows 11R may be separated from container-carrier web 82 by stamping machine 57. After containers 11 are freed from container-carrier web 82, they are then ready to be accumulated in the downstream accumulating step 65.

The accumulating step 65 is accomplished by nesting each individual multilayer container 11 in a neighboring container 11 so that a container stack 115 is established. As an example, containers 11 are nested in one another by operation of stamping machine 57 as shown in FIG. 1. Exemplary stamping machine 57 creates five separate container stacks 11S. After each container stack 115 includes a sufficient number of containers 11, container stack 11S is transported to a downstream brim-former machine (not shown).

Rolled brim 16 is formed on each container 11 in a brim-forming process. A brim-forming process is accomplished by passing container stack 11S through a brim-former machine (not shown).

A multilayer container 11 is formed during a container-thermoforming process as suggested in FIG. 1. It is within the scope of this disclosure to form multilayer container 11 to causing coating 72 to provide an exterior surface of container 11 or an interior surface of container 11. Container 11 is a precursor to drink cup 10. Container 11 includes a body 12 and an unrolled brim 15 as suggested in FIG. 1. The unrolled brim 15 is rolled in the brim-forming process to produce a rolled brim 16 shown in FIG. 3. Drink cup 10 is formed as a result of completing, in series, a multilayer container-thermoforming process and a brim-forming process.

For the purposes of non-limiting illustration only, formation of a drink cup from an exemplary embodiment of a multilayer container disclosed herein will be described. However, the container may be in any of a variety of possible shapes or structures or for a variety of applications, such as, but not limited to, a conventional beverage cup, storage container, bottle, or the like.

A sheet-forming process 100 is shown, for example, in FIG. 8. Sheet-forming process 100 includes a strip-forming process 101 and a downstream strip-coating process 102 and functions to produce a continuous multilayer sheet 70 as shown in FIG. 8.

Strip-forming process 101 extrudes a non-aromatic polymeric material into a continuous strip 71 made of insulative cellular non-aromatic polymeric material as suggested in FIG. 8. Strip-forming process 101 uses a tandem-extrusion technique in which a first extruder 111 and a second extruder 112 cooperate to extrude a continuous strip 71 made of insulative cellular non-aromatic polymeric material.

As shown in FIG. 8, a formulation 71F of insulative cellular non-aromatic polymeric material is loaded into a hopper 113 coupled to first extruder 111. The formulation 71F may be in pellet, granular flake, powder, or other suitable form. Formulation 71F of insulative cellular non-aromatic polymeric material is moved from hopper 113 by a screw 114A included in first extruder 111. Formulation 71F is transformed into a molten resin 122 in a first extrusion zone of first extruder 111 by application of heat 105 and pressure from screw 114A as suggested in FIG. 8. In exemplary embodiments a physical blowing agent may be introduced and mixed into molten resin 122 after molten resin 122 is established. In exemplary embodiments, as discussed further herein, the physical blowing agent may be a gas introduced as a pressurized liquid via a port 115A and mixed with molten resin 122 to form a molten extrusion resin mixture 123, as shown in FIG. 8.

Extrusion resin mixture 123 is conveyed by screw 114B into a second extrusion zone included in second extruder 112 as shown in FIG. 8. There, extrusion resin mixture 123 is further processed by second extruder 112 before being expelled through an extrusion die 116 coupled to an end of second extruder 112 to form an extrudate 124. As extrusion resin mixture 123 passes through extrusion die 116, gas comes out of solution in extrusion resin mixture 123 and begins to form cells and expand so that extrudate 104 is established. As an exemplary embodiment shown in FIG. 8, the extrudate 104 may be formed by an annular extrusion die 116 to form a tubular extrudate 124. A slitter 117 then cuts extrudate 124 to establish a continuous strip 71 of insulative cellular non-aromatic polymeric material as shown in FIG. 8. In one illustrative example, strip 71 of insulative cellular non-aromatic polymeric material is mated with a coating 72 in a strip coater 118 to produce a multilayer sheet 70 having a strip layer 71 and a coating layer 72 as suggested in FIG. 8.

Extrudate means the material that exits an extrusion die. The extrudate material may be in a form such as, but not limited to, a sheet, strip, tube, thread, pellet, granule or other structure that is the result of extrusion of a polymer-based formulation as described herein through an extruder die. For the purposes of illustration only, a sheet will be referred to as a representative extrudate structure that may be formed and then coated, but is intended to include the structures discussed herein. The extrudate may be further formed into any of a variety of final products, such as, but not limited to, cups, containers, trays, wraps, wound rolls of strips of insulative cellular non-aromatic polymeric material, or the like.

As an example, a continuous multilayer sheet 70 comprising a strip 71 of insulative cellular non-aromatic polymeric material and a coating 72 is wound to form a roll 70R and stored for later use either in a container-thermoforming process of the type illustrated in FIG. 1. However, it is within the scope of the present disclosure for multilayer sheet 70 to be used in line with the container-thermoforming process.

An insulative cup 10 is formed using a multilayer sheet 70 comprising a strip 71 of insulative cellular non-aromatic polymeric material and a coating 72 applied to strip 71 as shown in FIG. 3. Insulative cup 10 includes, for example, a body 12 having a sleeve-shaped side wall 18 and a floor 20 coupled to body 12 to cooperate with the side wall 18 to form an interior region 14 for storing food, liquid, or any suitable product as shown in FIG. 2. Body 12 also includes a rolled brim 16 coupled to an upper end of side wall 18 and a floor mount 17 coupled to a lower end of side wall 18 and to the floor 20.

An insulative tray 110 is formed using multilayer sheet 70 as shown in FIGS. 5 and 6. Insulative tray 110 includes, for example, a body 112 having a side wall 118 and a floor 120 coupled to body to cooperate with side wall 118 to form an interior region 114 as shown in FIG. 5. Body 112 also includes a brim 116 coupled to an upper end of side wall 118.

The material of the present disclosure in various embodiments can be used in shallow-draw thermoforming (i.e., draw depth less than or equal to about 2 inches), medium-draw thermoforming (i.e., draw depth greater than about 2 inches but less than about 4.5 inches, and deep-draw thermoforming (i.e., draw depth greater than about 4.5 inches or a depth greater than about half of the diameter of the product).

In one example, formulation 71F may be adjusted to increase the elasticity of the material and minimize fracturing. Examples 1 and 2 in the EXAMPLE portion of the application may be used in shallow-draw thermoforming applications. Examples 3-5 may be used in medium-draw thermoforming applications. Example 6 may be used deep-draw thermoforming applications.

In exemplary embodiments, a formulation includes at least two polymeric materials. In one exemplary embodiment, a primary or base polymer comprises a high melt strength polypropylene that has long chain branching. In one exemplary embodiment, the polymeric material also has non-uniform dispersity. Long chain branching occurs by the replacement of a substituent, e.g., a hydrogen atom, on a monomer subunit, by another covalently bonded chain of that polymer, or, in the case of a graft copolymer, by a chain of another type. For example, chain transfer reactions during polymerization could cause branching of the polymer. Long chain branching is branching with side polymer chain lengths longer than the average critical entanglement distance of a linear polymer chain. Long chain branching is generally understood to include polymer chains with at least 20 carbon atoms depending on specific monomer structure used for polymerization. Another example of branching is by crosslinking of the polymer after polymerization is complete. Some long chain branch polymers are formed without crosslinking. Polymer chain branching can have a significant impact on material properties. Originally known as the polydispersity index, dispersity is the measured term used to characterize the degree of polymerization. For example, free radical polymerization produces free radical monomer subunits that attach to other free radical monomers subunits to produce distributions of polymer chain lengths and polymer chain weights. Different types of polymerization reactions such as living polymerization, step polymerization, and free radical polymerization produce different dispersity values due to specific reaction mechanisms. Dispersity is determined as the ratio of weight average molecular weight ratio to number average molecular weight. Uniform dispersity is generally understood to be a value near or equal to 1. Non-uniform dispersity is generally understood to be a value greater than 2. Final selection of a polypropylene material may take into account the properties of the end material, the additional materials needed during formulation, as well as the conditions during the extrusion process. In exemplary embodiments, high melt strength polypropylenes may be materials that can hold a gas (as discussed hereinbelow), produce desirable cell size, have desirable surface smoothness, and have an acceptable odor level (if any).

One illustrative example of a suitable polypropylene base resin is DAPLOY™ WB140 homopolymer (available from Borealis A/S), a high melt strength structural isomeric modified polypropylene homopolymer (melt strength=36, as tested per ISO 16790 which is incorporated by reference herein, melting temperature=325.4° F. (163° C.) using ISO 11357, which is incorporated by reference herein).

Borealis DAPLOY™ WB140 properties (as described in a Borealis product brochure):

| Property | Typical Value | Unit | Test Method |
|---|---|---|---|
| Melt Flow Rate (230/2.16) | 2.1 | g/10 min | ISO 1133 |
| Flexural Modulus | 1900 | MPa | ISO 178 |
| Tensile Strength at Yield | 40 | MPa | ISO 527-2 |
| Elongation at Yield | 6 | % | ISO 527-2 |
| Tensile Modulus | 2000 | MPa | ISO 527-2 |
| Charpy impact strength, | 3.0 | kJ/m² | ISO 179/1eA |
| notched (+23° C.) | | | |
| Charpy impact strength, | 1.0 | kJ/m² | ISO 179/1eA |
| notched (−20° C.) | | | |
| Heat Deflection Temperature | 60 | ° C. | ISO 75-2 |
| A (at 1.8 MPa load) | | | Method A |
| Heat Deflection Temperature | 110 | ° C. | ISO 75-2 |
| B (at 0.46 MPa load) | | | Method B |

Other polypropylene polymers having suitable melt strength, branching, and melting temperature may also be used. Several base resins may be used and mixed together.

In certain exemplary embodiments, a secondary polymer may be used with the base polymer. The secondary polymer may be, for example, a polymer with sufficient crystallinity. The secondary polymer may also be, for example, a polymer with sufficient crystallinity and melt strength. In exemplary embodiments, the secondary polymer may be at least one crystalline polypropylene homopolymer, an impact polypropylene copolymer, mixtures thereof or the like. One illustrative example is a high crystalline polypropylene homopolymer, available as F020HC from Braskem. Another illustrative example is an impact polypropylene copolymer commercially available as PRO-FAX SC204™ (available from LyndellBasell Industries Holdings, B.V.). Another illustrative example include is Homo PP-INSPIRE 222, available from Braskem. Another illustrative example included is the commercially available polymer known as PP 527K, available from Sabic. Another illustrative example is a polymer commercially available as XA-11477-48-1 from LyndellBasell Industries Holdings, B.V. In one aspect the polypropylene may have a high degree of crystallinity, i.e., the content of the crystalline phase exceeds 51% (as tested using differential scanning calorimetry) at 10° C./min cooling rate. In exemplary embodiments, several different secondary polymers may be used and mixed together.

In exemplary embodiments, the secondary polymer may be or may include polyethylene. In exemplary embodiments, the secondary polymer may include low density polyethylene, linear low density polyethylene, high density polyethylene, ethylene-vinyl acetate copolymers, ethylene-ethylacrylate copolymers, ethylene-acrylic acid copolymers, polymethylmethacrylate mixtures of at least two of the foregoing and the like. The use of non-polypropylene materials may affect recyclability, insulation, microwavability, impact resistance, or other properties, as discussed further hereinbelow.

One or more nucleating agents are used to provide and control nucleation sites to promote formation of cells, bubbles, or voids in the molten resin during the extrusion process. Nucleating agent means a chemical or physical material that provides sites for cells to form in a molten resin mixture. Nucleating agents may be physical agents or chemical agents. Suitable physical nucleating agents have desirable particle size, aspect ratio, and top-cut properties, shape, and surface compatibility. Examples include, but are not limited to, talc, CaCO₃, mica, kaolin clay, chitin, aluminosilicates, graphite, cellulose, and mixtures of at least two of the foregoing. The nucleating agent may be blended with the polymer resin formulation that is introduced into the hopper. Alternatively, the nucleating agent may be added to the molten resin mixture in the extruder. When the chemical reaction temperature is reached the nucleating agent acts to enable formation of bubbles that create cells in the molten resin. An illustrative example of a chemical blowing agent is citric acid or a citric acid-based material. After decomposition, the chemical blowing agent forms small gas cells which further serve as nucleation sites for larger cell growth from physical blowing agents or other types thereof. One representative example is Hydrocerol™ CF-40E™ (available from Clariant Corporation), which contains citric acid and a crystal nucleating agent. Another representative example is Hydrocerol™ CF-05E™ (available from Clariant Corporation), which contains citric acid and a crystal nucleating agent. In illustrative embodiments one or more catalysts or other reactants may be added to accelerate or facilitate the formation of cells.

In some embodiments, a beta nucleator may be used. One beat nucleator is available from MAYZO and is MPM® 1114 Beta Nucleant Masterbatch. The beta nucleator may be 0% to about 2% by weight percentage of the total formulation. In another example, the beta nucleator may be about 1% by weight percentage of the total formulation.

In another embodiment, an impact modifier may be used. One impact modifier is available from ExxonMobil Chemical and is VISTAMAXX™ PBE. The impact modifier may about 5% to about 20% by weight percentage of the total formulation. In another example, the impact modifier may be about 15% by weight of the total formulation.

In certain exemplary embodiments, one or more blowing agents may be incorporated. Blowing agent means a physical or a chemical material (or combination of materials) that acts to expand nucleation sites. Nucleating agents and blowing agents may work together. The blowing agent acts to reduce density by forming cells in the molten resin. The blowing agent may be added to the molten resin mixture in the extruder. Representative examples of physical blowing agents include, but are not limited to, carbon dioxide, nitrogen, helium, argon, air, water vapor, pentane, butane, or other alkane mixtures of the foregoing and the like. In certain exemplary embodiments, a processing aid may be employed that enhances the solubility of the physical blowing agent. Alternatively, the physical blowing agent may be a hydrofluorocarbon, such as 1,1,1,2-tetrafluoroethane, also known as R134a, a hydrofluoroolefin, such as, but not limited to, 1,3,3,3-tetrafluoropropene, also known as HFO-1234ze, or other haloalkane or haloalkane refrigerant. Selection of the blowing agent may be made to take environmental impact into consideration.

In exemplary embodiments, physical blowing agents are typically gases that are introduced as liquids under pressure into the molten resin via a port in the extruder. As the molten resin passes through the extruder and the die head, the pressure drops causing the physical blowing agent to change phase from a liquid to a gas, thereby creating cells in the extruded resin. Excess gas blows off after extrusion with the remaining gas being trapped in the cells in the extrudate.

Chemical blowing agents are materials that degrade or react to produce a gas. Chemical blowing agents may be endothermic or exothermic. Chemical blowing agents typically degrade at a certain temperature to decompose and release gas. In one aspect the chemical blowing agent may be one or more materials selected from the group consisting of azodicarbonamide; azodiisobutyro-nitrile; benzenesulfonhydrazide; 4,4-oxybenzene sulfonylsemicarbazide; p-toluene sulfonyl semi-carbazide; barium azodicarboxylate; N,N′-dimethyl-N,N′-dinitrosoterephthalamide; trihydrazino triazine; methane; ethane; propane; n-butane; isobutane; n-pentane; isopentane; neopentane; methyl fluoride; perfluoromethane; ethyl fluoride; 1,1-difluoroethane; 1,1,1-trifluoroethane; 1,1,1,2-tetrafluoro-ethane; pentafluoroethane; perfluoroethane; 2,2-difluoropropane; 1,1,1-trifluoropropane; perfluoropropane; perfluorobutane; perfluorocyclobutane; methyl chloride; methylene chloride; ethyl chloride; 1,1,1-trichloroethane; 1,1-dichloro-1-fluoroethane; 1-chloro-1,1-difluoroethane; 1,1-dichloro-2,2,2-trifluoroethane; 1-chloro-1,2,2,2-tetrafluoroethane; trichloromonofluoromethane; dichlorodifluoromethane; trichlorotrifluoroethane; dichlorotetrafluoroethane; chloroheptafluoropropane; dichlorohexafluoropropane; methanol; ethanol; n-propanol; isopropanol; sodium bicarbonate; sodium carbonate; ammonium bicarbonate; ammonium carbonate; ammonium nitrite; N,N′-dimethyl-N,N′-dinitrosoterephthalamide; N,N′-dinitrosopentamethylene tetramine; azodicarbonamide; azobisisobutylonitrile; azocyclohexylnitrile; azodiaminobenzene; bariumazodicarboxylate; benzene sulfonyl hydrazide; toluene sulfonyl hydrazide; p,p′-oxybis(benzene sulfonyl hydrazide); diphenyl sulfone-3,3′-disulfonyl hydrazide; calcium azide; 4,4′-diphenyl disulfonyl azide; and p-toluene sulfonyl azide.

In one aspect of the present disclosure, where a chemical blowing agent is used, the chemical blowing agent may be introduced into the resin formulation that is added to the hopper.

In one aspect of the present disclosure, the blowing agent may be a decomposable material that forms a gas upon decomposition. A representative example of such a material is citric acid or a citric-acid based material. In one exemplary aspect of the present disclosure it may be possible to use a mixture of physical and chemical blowing agents.

In one aspect of the present disclosure, at least one slip agent may be incorporated into the resin mixture to aid in increasing production rates. Slip agent (also known as a process aid) is a term used to describe a general class of materials which are added to a resin mixture and provide surface lubrication to the polymer during and after conversion. Slip agents may also reduce or eliminate die drool. Representative examples of slip agent materials include amides of fats or fatty acids, such as, but not limited to, erucamide and oleamide. In one exemplary aspect, amides from oleyl (single unsaturated C₁₈) through erucyl (C₂₂ single unsaturated) may be used. Other representative examples of slip agent materials include low molecular weight amides and fluoroelastomers. Combinations of two or more slip agents can be used. Slip agents may be provided in a master batch pellet form and blended with the resin formulation.

One or more additional components and additives optionally may be incorporated, such as, but not limited to, impact modifiers, colorants (such as, but not limited to, titanium dioxide), and compound regrind. Additional disclosure related to insulative cellular non-aromatic polymeric material may be found in U.S. patent application Ser. No. 14/063,252, filed on May 1, 2014 is hereby incorporated by reference herein in its entirety.

Thermoforming of multi-layer sheet 70 may be maximized through the use of matched metal thermoforming dies as shown, for example, in FIG. 2. Match metal thermoforming dies may be used to create containers having at least some deformation throughout the container and a minimum deformation of at least 2% throughout.

In some embodiments, a multi-layer sheet includes strip 71 of insulative cellular non-aromatic polymeric material, and one or more layers. In one example, the additional layer is a film laminated to strip 71. One example of a laminated film in accordance with the present disclosure is BICOR™ 18 MAT (available from ExxonMobil Chemical) oriented polypropylene film.

In other embodiments, a multi-layer sheet includes strip 71 of insulative cellular non-aromatic polymeric material and one or more extrusion webs having various chemistries. The one or more extrusion webs are configured to minimize cell deformation and maximize forming strength. One layer of an extrusion web may be made from DAPLOY™ WB120HMS (available from Borealis AG) high melt strength polypropylene. Another layer of an extrusion web may be made from DAPLOY™ WB130HMS (available from Borealis AG) high melt strength polypropylene. Still yet another layer of an extrusion web may be made from DAPLOY™ WB135HMS (available from Borealis AG) high melt strength polypropylene. Another layer of an extrusion web may be made from DAPLOY™ WB140HMS (available from Borealis AG) high melt strength polypropylene. Yet another layer of an extrusion web may be made from DAPLOY™ WB180HMS (available from Borealis AG) high melt strength polypropylene. Another layer of an extrusion web may be made from DAPLOY™ WB260HMS (available from Borealis AG) high melt strength polypropylene. The multi-layer sheet may include one or more extrusion webs.

In another illustrative embodiment, a multi-layer sheet may include strip 71 of insulative cellular non-aromatic polymeric material and a cast film. The cast film allows for adequate material stretch without film fractures to carry the decoration or using a direct print post form process (dry offset).

### EXAMPLES

The following examples are set forth for purposes of illustration only. Parts and percentages appearing in such examples are by weight unless otherwise stipulated. All ASTM, ISO and other standard test method cited or referred to in this disclosure are incorporated by reference in their entirety.

### Example 1

### Formulation and Extrusion

DAPLOY™ WB140 polypropylene homopolymer (available from Borealis A/S) was used as the polypropylene base resin. F020HC, available from Braskem, a polypropylene homopolymer resin, was used as the secondary resin. The two resins were blended with: Hydrocerol™ CF-40E™ as a chemical blowing agent, talc as a nucleation agent, CO₂ as a physical blowing agent, a slip agent, and titanium dioxide as a colorant. The colorant can be added to the base resin or to the secondary resin and may be done prior to mixing of the two resins. Percentages were:

| | |
|---|---|
| 81.4% | Primary Resin: Borealis WB140 HMS high melt strength |
| | homopolymer polypropylene |
| 15% | Secondary Resin: Braskem F020HC homopolymer |
| | polypropylene |
| 0.5% | Chemical Blowing Agent: Clariant Hyrocerol CF-40E ™ |
| 0.5% | Nucleation Agent: Heritage Plastics HT4HP Talc |
| 1% | Colorant: Ampacet J11 White |
| 2% | Slip agent: Ampacet ™ 102823 Process Aid LLDPE (linear low- |
| | density polyethylene), available from Ampacet Corporation |

The formulation was added to an extruder hopper. The extruder heated the formulation to form a molten resin mixture. To this mixture was added a physical blowing agent to expand the resin and reduce density. The mixture thus formed was extruded through a die head into a strip. The strip was then thermoformed into insulative cup.

### Example 2

### Formulation and Extrusion

DAPLOY™ WB140 HMS polypropylene homopolymer (available from Borealis A/S) was used as the polypropylene base resin. F020HC polypropylene homopolymer resin (available from Braskem), was used as the secondary resin. The two resins were blended with: Hydrocerol™ CF-40E™ as a primary nucleation agent, talc as a nucleation agent, CO₂ as a blowing agent, Ampacet™ 102823 LLDPE as a slip agent, a beta nucleator, and titanium dioxide as a colorant. The colorant can be added to the base resin or to the secondary resin and may be done prior to mixing of the two resins. Percentages were:

| | |
|---|---|
| 80.9% | Primary Resin: Borealis WB140 HMS high melt strength |
| | homopolymer polypropylene |
| 15% | Secondary Resin: Braskem F020HC homopolymer |
| | polypropylene |
| 0.5% | Chemical Blowing Agent: Clariant Hyrocerol CF-40E ™ 15% |
| 0.5% | Beta Nucleator: MAYZO MPM ® 1114 Beta Nucleant |
| | Masterbatch |
| 0.1% | Nucleation Agent: Heritage Plastics HT4HP Talc |
| 1% | Colorant: Ampacet J11 White |
| 2% | Slip agent: Ampacet ™ 102823 Process Aid LLDPE (linear |
| | low-density polyethylene), available from Ampacet Corporation |

The formulation was added to an extruder hopper. The extruder heated the formulation to form a molten resin mixture. To this mixture was added a blowing agent. The blowing agent was injected into the resin blend to expand the resin and reduce density. The mixture thus formed was extruded through a die head into a sheet. The strip was then thermoformed into insulative cup.

### Example 3

### Formulation and Extrusion

DAPLOY™ WB140 HMS polypropylene homopolymer (available from Borealis A/S) was used as the polypropylene base resin. The base resin was blended with: Hydrocerol™ CF-40E™ as a primary nucleation agent, talc as a nucleation agent, CO₂ as a blowing agent, Ampacet™ 102823 LLDPE as a slip agent, and titanium dioxide as a colorant. The colorant can be added to the base resin or to the secondary resin and may be done prior to mixing of the resins. Percentages were:

| | |
|---|---|
| 96.4% | Primary Resin: Borealis WB140 HMS high melt strength |
| | homopolymer polypropylene |
| 0.1% | Chemical Blowing Agent: Clariant Hyrocerol CF-40E ™ 15% |
| 0.5% | Nucleation Agent: Heritage Plastics HT4HP Talc |
| 1% | Colorant: Ampacet J11 White |
| 2% | Slip agent: Ampacet ™ 102823 Process Aid LLDPE (linear low- |
| | density polyethylene), available from Ampacet Corporation |

The formulation was added to an extruder hopper. The extruder heated the formulation to form a molten resin mixture. To this mixture was added a blowing agent. The blowing agent was injected into the resin blend to expand the resin and reduce density. The mixture thus formed was extruded through a die head into a sheet. The strip was then thermoformed into insulative cup.

### Example 4

### Formulation and Extrusion

DAPLOY™ WB140 HMS polypropylene homopolymer (available from Borealis A/S) was used as the polypropylene base resin. VISTAMAXX™ PBE (available from ExxonMobil Chemical) was used as an impact modifier. The two resins were blended with: Hydrocerol™ CF-40E™ as a primary nucleation agent, talc as a nucleation agent, CO₂ as a blowing agent, Ampacet™ 102823 LLDPE as a slip agent, and titanium dioxide as a colorant. The colorant can be added to the base resin or to the secondary resin and may be done prior to mixing of the two resins. Percentages were:

| | |
|---|---|
| 81.4% | Primary Resin: Borealis WB140 HMS high melt strength |
| | homopolymer polypropylene |
| 15% | Impact Modifier: VISTAMAXX ™ PBE |
| 0.1% | Chemical Blowing Agent: Clariant Hyrocerol CF-40E ™ 15% |
| 0.5% | Nucleation Agent: Heritage Plastics HT4HP Talc |
| 1% | Colorant: Ampacet J11 White |
| 2% | Slip agent: Ampacet ™ 102823 Process Aid LLDPE (linear low- |
| | density polyethylene), available from Ampacet Corporation |

The formulation was added to an extruder hopper. The extruder heated the formulation to form a molten resin mixture. To this mixture was added a blowing agent. The blowing agent was injected into the resin blend to expand the resin and reduce density. The mixture thus formed was extruded through a die head into a sheet. The strip was then thermoformed into insulative cup.

### Example 5

### Formulation and Extrusion

DAPLOY™ WB140 HMS polypropylene homopolymer (available from Borealis A/S) was used as the polypropylene base resin. F020HC polypropylene homopolymer resin (available from Braskem), was used as the secondary resin. The two resins were blended with: Hydrocerol™ CF-40E™ as a primary nucleation agent, talc as a nucleation agent, CO₂ as a blowing agent, Ampacet™ 102823 LLDPE as a slip agent, a beta nucleator, and titanium dioxide as a colorant. The colorant can be added to the base resin or to the secondary resin and may be done prior to mixing of the two resins. Percentages were:

| | |
|---|---|
| 80.4% | Primary Resin: Borealis WB140 HMS high melt strength |
| | homopolymer polypropylene |
| 15% | Secondary Resin: Braskem F020HC homopolymer |
| | polypropylene |
| 0.5% | Chemical Blowing Agent: Clariant Hyrocerol CF-40E ™ 15% |
| 1.0% | Beta Nucleator: MAYZO MPM ® 1114 Beta Nucleant |
| | Masterbatch |
| 0.5% | Nucleation Agent: Heritage Plastics HT4HP Talc |
| 1% | Colorant: Ampacet J11 White |
| 2% | Slip agent: Ampacet ™ 102823 Process Aid LLDPE (linear low- |
| | density polyethylene), available from Ampacet Corporation |

The formulation was added to an extruder hopper. The extruder heated the formulation to form a molten resin mixture. To this mixture was added a blowing agent. The blowing agent was injected into the resin blend to expand the resin and reduce density. The mixture thus formed was extruded through a die head into a sheet. The strip was then thermoformed into insulative cup.

### Example 6

### Formulation and Extrusion

DAPLOY™ WB140 HMS polypropylene homopolymer (available from Borealis A/S) was used as the polypropylene base resin. A high melt strength polypropylene was used as the secondary resin. The secondary resin may be a homopolymer or random copolymer that has a wide unimodal distribution with polydispersity index (10 or more), an MFI of around 1.5 to 3, and high melting point above 150 degrees Celsius. These attributes of the secondary resin will allow for the melt to process and extrude at higher temperatures from the secondary extruder, which allows the melt strength to sustain during thermoforming, as higher processing extrusion temperatures generally translates to an ability to hold melt strength at higher temperatures. The two resins were blended with: Hydrocerol™ CF-40E™ as a primary nucleation agent, talc as a nucleation agent, CO₂ as a blowing agent, Ampacet™ 102823 LLDPE as a slip agent, and titanium dioxide as a colorant. The colorant can be added to the base resin or to the secondary resin and may be done prior to mixing of the two resins. Percentages were:

| | |
|---|---|
| 71.4% | Primary Resin: Borealis WB140 HMS high melt strength |
| | homopolymer polypropylene |
| 25% | Secondary Resin: High Melt Strength Polypropylene |
| 0.1% | Chemical Blowing Agent: Clariant Hyrocerol CF-40E ™ |
| 0.5% | Nucleation Agent: Heritage Plastics HT4HP Talc |
| 1% | Colorant: Ampacet J11 White |
| 2% | Slip agent: Ampacet ™ 102823 Process Aid LLDPE (linear low- |
| | density polyethylene), available from Ampacet Corporation |

The formulation was added to an extruder hopper. The extruder heated the formulation to form a molten resin mixture. To this mixture was added a blowing agent. The blowing agent was injected into the resin blend to expand the resin and reduce density. The mixture thus formed was extruded through a die head into a sheet. The strip was then thermoformed into insulative cup.

1. A process for thermoforming an insulative container comprising a polymeric material, the process comprising the steps of
extruding a strip made of an insulative cellular non-aromatic polymeric material,
applying a coating to the strip to form a sheet, and
thermoforming the sheet to produce insulative containers having a first layer comprising the insulative cellular non-aromatic polymeric material and a second layer comprising the coating.

2. The process of claim 1, wherein the sheet is drawn to a depth that is greater than about two inches during the thermoforming step.

3. The process of claim 1, wherein the insulative container has a diameter and the sheet is drawn to a depth that is greater than about half of the diameter of the insulative container.

4. The process of claim 1, wherein a foam formulation included in the insulative cellular non-aromatic polymeric material includes means for increasing elasticity of the insulative cellular non-aromatic polymeric material to minimize foam fracturing during the thermoforming step.

5. The process of claim 4, wherein the means for increasing elasticity of the insulative cellular non-aromatic polymeric material is an impact modifier.

6. The process of claim 4, wherein means for increasing elasticity of the insulative cellular non-aromatic polymeric material is a beta nucleator.

7. The process of claim 1, wherein the insulative cellular non-aromatic polymeric material has a cell aspect ratio of about one.

8. The process of claim 1, wherein a multilayer extrusion web with various chemistries is created during the applying step to minimize cell deformation and maximize forming strength.

9. A process for thermoforming an insulative container comprising a polymeric material, the process comprising the steps of
extruding a strip made of an insulative cellular non-aromatic polymeric material,
laminating a cast film coating to the strip to form a sheet, and
thermoforming the sheet to produce insulative containers having a first layer comprising the insulative cellular non-aromatic polymeric material and a second layer comprising the coating.

10. The process of claim 9, wherein the cast film is configured to provide means for allowing adequate material stretch without film fracture during the thermoforming step.

11. The process of claim 10, further comprising printing a decoration on the cast film after the thermoforming step.
